(19) United States
(12) Patent Application Publication
(10) Pub. No.: US 2019/0156579 A1
(43) Pub. Date: May 23, 2019

(54) Mixed reality video production with detached camera

(71) Applicant: Blueprint Reality Inc., Vancouver (CA)

(72) Inventors: Benjamin James Sheftel, Vancouver (CA); Tryon Williams, West Vancouver (CA)

(21) Appl. No.: 15/821,838

(22) Filed: Nov. 23, 2017

(51) Int. Cl. G06T 19/00; H04N 7/18; G06T 3/00; G06T 7/70; G06T 7/194; H04N 5/232

(52) U.S. Cl. CPC G06T 19/006; H04N 7/185; G06T 3/0087; G06T 2207/10016; G06T 7/194; H04N 5/23293; G06T 2207/30244; G06T 7/70

(57) ABSTRACT

An unmounted camera, which is used to capture images of a user of a virtual reality application, wirelessly transmits its position, orientation and the camera feed to a computer. The computer determines the location and orientation of the camera in the virtual world and renders a view of the virtual scene from the perspective of the camera. The computer compensates for latency in the camera feed. The user's background is removed from the camera feed and the image of the user is composited with the rendered scene to result in a mixed reality scene. The composited scene is displayed back to the camera operator, either locally or on a separate screen. The system provides the freedom to the camera operator to introduce camera movement in mixed reality video productions.

### TECHNICAL FIELD

This application relates to the field of computer-altered video production. In particular, it relates to the use of a physically detached, wireless camera to capture a real scene that is composited with a view of a virtual scene.

### BACKGROUND

Mixed reality (MR) broadcasting is the act of producing and presenting images in real time of a user of a virtual reality (VR) or augmented reality (AR) application composited with the virtual scene that the user inhabits. This process requires obtaining images and/or video from a camera and combining them with a synchronized view of a virtual scene from the perspective of the camera.

Currently, this process is restricted to being run on a single processing unit, i.e. personal computer (PC) hardware, as no other platforms are capable of interfacing with a camera device directly while also simulating and rendering a view of the virtual scene. Cameras are therefore limited to those capable of a wired connection to the computer, i.e. cameras that are physically constrained to the computer.

To make the video content from this output more compelling, camera movement is sometimes permitted, provided that a tracking system is used to detect the position of the camera. Such a tracking system may be an additional tracked accessory for the VR headset's tracking system. The current steps involved are: updating the virtual camera position from the latest tracking data, if tracked; rendering a view of the virtual scene; receiving an image from the input source, i.e. the camera; compositing the input image with the view of virtual scene; and outputting the result to the application window.

FIG. 1 shows prior art system 10 for MR broadcasting. A background set 35 includes a wall 36 and floor 38, both covered with a green screen 40. A subject 50 is present and wearing VR headset 52 that is wirelessly connected 54 to a PC 66. The PC is also connected to a monitor 70 with a screen 72. The subject 50 is holding controllers 56, which are also wirelessly connected 58 to the PC 66. Under control of the PC 66, the VR headset 52 displays to the subject 50 a view of a virtual scene. The position and orientation of the headset 52 and controllers 56 are tracked by the PC 66. The PC is connected via a wired connection 65 to a camera 60 that is mounted on rails 61, which permit limited movement in directions shown by the arrows 62, for example. The camera 60 is directed such that its field of view 68 captures the background set 35. The green screen in the images captured by the camera is removed by the PC 66, by chroma keying, so that the image 74 of the subject can be composited onto the view of the virtual scene 76 viewed from the perspective of the camera 60. In some cases, a tracking device 64 is attached to the camera 60.

This background information is provided to reveal information believed by the applicant to be of possible relevance to the present invention. No admission is necessarily intended, nor should be construed, that any of the preceding information constitutes prior art against the present invention.

### SUMMARY OF INVENTION

This invention allows for the production of mixed reality (MR) videos and video streams using a camera that is detached from the computing device that composits the MR video. The inventor has recognized that the current levels of connectivity needed between the physical devices required for MR video production are too restrictive in how they allow the cameras to be accessed and moved. By moving to a distributed system, which allows multiple devices to connect over wireless transmission and share data, new approaches to MR cinematography can be achieved. The system disclosed herein permits the four major components of an MR video production system to be distributed in up to four separate physical devices and to coordinate wirelessly at runtime to produce MR output, with a much broader range of options for achieving the output than currently available. The four main components are the application processing device, such as a PC; the input camera; the output display; and the camera tracking system.

The camera's position and orientation are tracked wirelessly, and a latency-compensated MR video is composited on the fly and displayed back to the camera operator, thereby providing real-time feedback, or near real-time feedback subject to latency. Display of the output is either local, i.e. on a screen of the camera, or remote, such as on a video display connected to a PC and observable by the camera operator.

Disclosed herein is a method for producing a mixed reality video comprising the steps of: creating, by a processor, a virtual reality scene; detecting, by the processor, a wireless connection of a detached camera to the processor; guiding a subject experiencing the virtual scene through a calibration process that results in a determination of a transformation matrix from a frame of reference of the camera to a frame of reference of the virtual reality scene; receiving, by the processor, a video frame of the subject and a background to the subject captured by the camera; receiving, by the processor, a position and orientation of the camera in the camera's frame of reference corresponding to when the camera captured the video frame; determining, by the processor, a position and orientation of the camera in the frame of reference of the virtual scene using the transformation matrix; creating, by the processor, a view of the virtual scene from a perspective of the position and orientation of the camera in the frame of reference of the virtual scene; removing, by the processor, the background from the video frame; compositing the video frame of the subject with the view of the virtual scene; and relaying the composited view of the virtual scene to a display device.

The method further comprises: receiving, by the processor, subsequent video frames of the subject and the background to the subject captured by the camera; receiving, by the processor, a position and orientation of the camera in the camera's frame of reference corresponding to each subsequent video frame; updating, by the processor, the position and orientation of the camera in the frame of reference of the virtual scene for each subsequent video frame; creating, by the processor, a view of the virtual scene from a perspective of each updated position and orientation of the camera in the frame of reference of the virtual scene; removing, by the processor, the background from each subsequent video frame; compositing each subsequent video frame of the subject with each corresponding view of the virtual scene; and relaying each composited view of the virtual scene in sequence to the display device.

Further disclosed is a system for producing a mixed reality video comprising: a physically detached camera; a background set; a display device; anda processor. The processor is configured to: create a virtual reality scene; detect a wireless connection of the camera to the processor; guide a subject experiencing the virtual scene through a calibration process that results in a determination of a transformation matrix from a frame of reference of the camera to a frame of reference of the virtual reality scene; receive a video frame of the subject and the background set captured by the camera; receive a position and orientation of the camera in the camera's frame of reference corresponding to when the camera captured the video frame; determine a position and orientation of the camera in the frame of reference of the virtual scene; create a view of the virtual scene from a perspective of the position and orientation of the camera in the frame of reference of the virtual scene; remove the background from the video frame; composit the video frame of the subject with the view of the virtual scene; and relay the composited view of the virtual scene to the display device.

Still further disclosed is a non-transitory computer readable medium comprising computer-readable instructions, which, when executed by a processor cause the processor to: create a virtual reality scene; detect a wireless connection of a detached camera to the processor; guide a subject experiencing the virtual scene through a calibration process that results in a determination of a transformation matrix from a frame of reference of the camera to a frame of reference of the virtual reality scene; receive a video frame of the subject and a background to the subject captured by the camera; receive a position and orientation of the camera in the camera's frame of reference corresponding to when the camera captured the video frame; determine a position and orientation of the camera in the frame of reference of the virtual scene; create a view of the virtual scene from a perspective of the position and orientation of the camera in the frame of reference of the virtual scene; remove the background from the video frame; composit the video frame of the subject with the view of the virtual scene; and relay the composited view of the virtual scene to the display device.

### BRIEF DESCRIPTION OF DRAWINGS

The following drawings illustrate an embodiment of the invention, and should not be construed as restricting the scope of the invention in any way. The drawings are not to scale.

FIG. 1 is a schematic diagram of a prior art system for MR video production.

FIG. 2 is a schematic diagram of a system for MR video production, according to an embodiment of the present invention.

FIG. 3 is a flowchart of the main steps undertaken by a system for MR video production, according to an embodiment of the present invention.

FIG. 4 is a schematic diagram of an alternate mode for tracking the camera in an MR video production system, according to an embodiment of the present invention.

FIG. 5 is a schematic diagram of a drone carrying the camera, according to an embodiment of the present invention.

FIG. 6 is a schematic diagram showing a separate device used for compositing, according to an embodiment of the present invention.

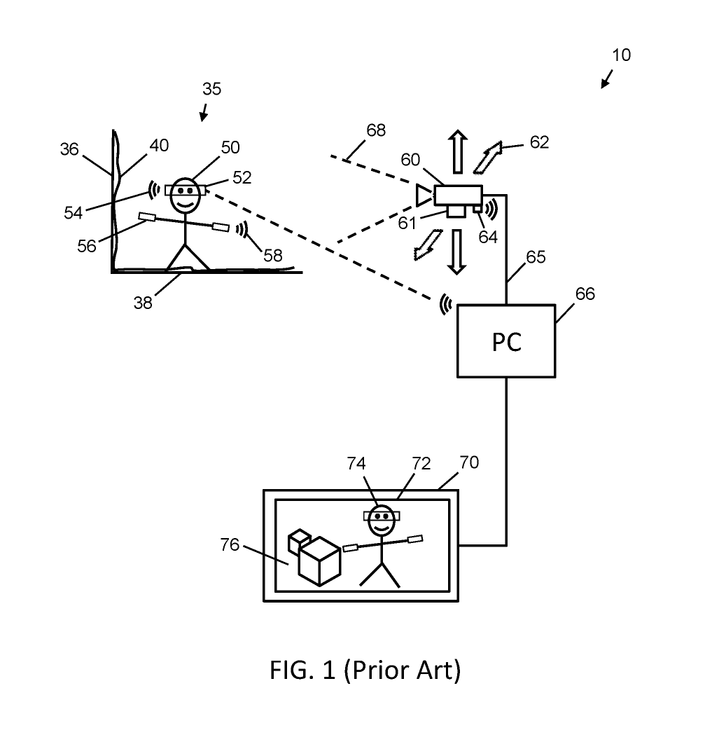

### DESCRIPTION

### A. Glossary

The term “augmented reality (AR)” refers to a view of a real-world scene that is superimposed with added computer-generated detail. The view of the real-world scene may be an actual view through glass, on which images can be generated, or it may be a video feed of the view that is obtained by a camera.

The term “virtual reality (VR)” refers to a scene that is entirely computer-generated and displayed in virtual reality goggles or a VR headset, and that changes to correspond to movement of the wearer of the goggles or headset. The wearer of the headset can therefore look and “move” around in the virtual world created by the headset.

The term “mixed reality (MR)” refers to the creation of a video of real-world objects in a virtual reality scene. For example, an MR video may include a person playing a virtual reality game composited with the computer-generated scenery in the game that surrounds the person.

The term “network” can include both a mobile network and data network without limiting the term's meaning, and includes the use of wireless (e.g. 2G, 3G, 4G, WiFi, WiMAX™, Wireless USB (Universal Serial Bus), Zigbee™, Bluetooth™ and satellite), and/or hard wired connections such as local, internet, ADSL (Asymmetrical Digital Subscriber Line), DSL (Digital Subscriber Line), cable modem, T1, T3, fibre, dial-up modem, television cable, and may include connections to flash memory data cards and/or USB memory sticks where appropriate. A network could also mean dedicated connections between computing devices.

The term “processor” is used to refer to any electronic circuit or group of circuits that perform calculations, and may include, for example, single or multicore processors, multiple processors, an ASIC (Application Specific Integrated Circuit), and dedicated circuits implemented, for example, on a reconfigurable device such as an FPGA (Field Programmable Gate Array). The processor performs the steps in the flowcharts, whether they are explicitly described as being executed by the processor or whether the execution thereby is implicit due to the steps being described as performed by code or a module. Where the processor comprises multiple processors, they may be located together or geographically separate from each other. The term includes virtual processors and machine instances as in cloud computing or local virtualization, which are ultimately grounded in physical processors.

The term “system” without qualification refers to the invention as a whole, i.e. a system for MR video production using a detached camera. The system may include or use sub-systems.

The term “chroma keying” refers to the removal of a background from a video that has a subject in the foreground. A color range in the video corresponding to the background is made transparent, so that when the video is overlaid on another scene or video, the subject appears to be in the other scene or video.

### B. Exemplary System

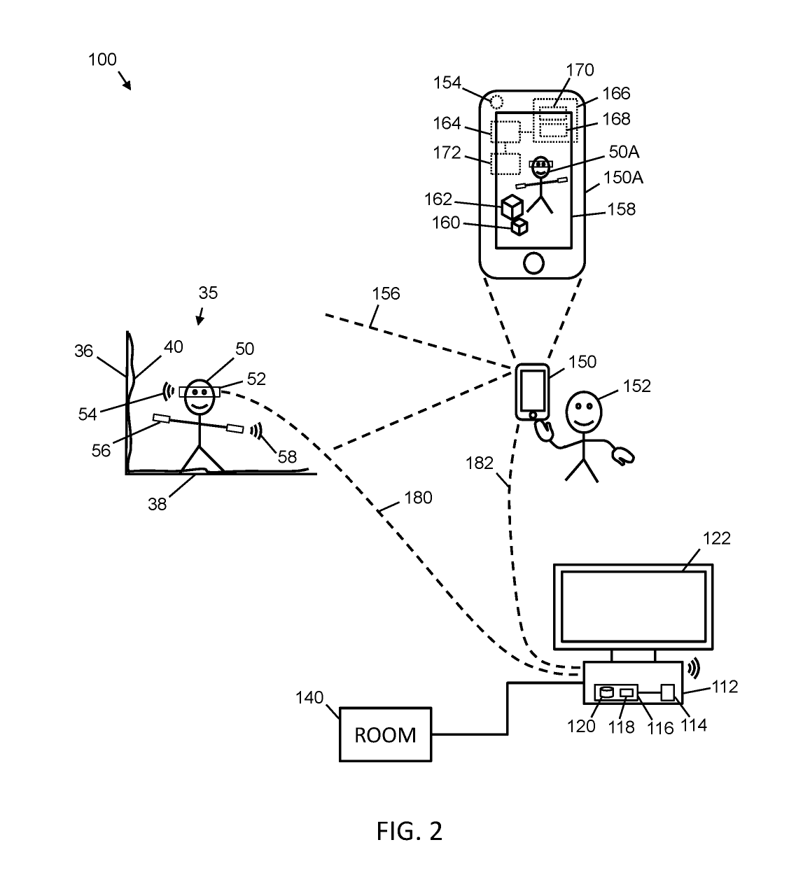

Referring to FIG. 2, there is shown an exemplary system 100 for MR video production using a detached camera 150, shown here as a smart device that includes a camera. The system 100 includes a background set 35 having a wall 36 and floor 38, both covered with a green screen 40 or other green screen. A subject 50 is present and is wearing a VR headset 52 that is wirelessly connected 54 to a PC 112. The subject 50 is also holding controllers 56, which are also wirelessly connected 58 to the PC 112.

The PC 112 includes one or more processors 114 which are operably connected to non-transitory computer readable memory 116 included in the PC. The PC 112 includes computer readable instructions 118 (e.g. an application) stored in the memory 116, and computer readable data 120, also stored in the memory. The computer readable instructions 118 and computer readable data 120 are used by the PC to create the virtual scene, permit the connection of a camera to the virtual scene, to chroma key, and to composit images and video, for example. Computer readable instructions 118 may be broken down into blocks of code or modules. The memory 116 may be divided into one or more constituent memories, of the same or different types. The PC 112 optionally includes a display screen 122, operably connected to the processor(s) 114. The display screen 122 may be a traditional screen, a touch screen, a projector, an electronic ink display or any other technological device for displaying information. The PC 112 wirelessly receives data regarding the position and orientation of the headset 52 and controllers 56 of the subject 50. Connections to the PC 112 may be interpreted as being connections to the processor 114 of the PC.

The PC 112 is configured to create a virtual scene in which a subject is virtually present. The PC 112 also creates a virtual networked room 140, via which external devices, such as a camera, can connect. The camera 150, also shown enlarged as 150A, detects the room 140 and allows the camera operator, who is holding the camera 150, to “enter” the room. The camera 150 is detached, i.e. unconstrained by a track, not mounted on a tripod, nor attached to any other physical device. The camera operator 152 aims the camera's objective 154 and the field of view 156 of the camera at the background set 35 and/or the subject 50, and produces a video feed. The video feed is wirelessly transmitted to the PC 112, which removes the image of the green screen 40 from the feed and composits the image of the subject 50 with a view of the virtual scene that the subject 50 is inhabiting. The PC 112 transmits the composited view of the scene back to the camera 150A, which displays the composited view of the scene on a screen 158 on the camera. The camera 150 is therefore capable of bi-directional video transmission. In this example, the screen 158 shows an image 50A of the subject 50 and elements 160, 162 of the virtual reality that the subject is inhabiting.

The camera 150, 150A includes one or more processors 164 which are operably connected to non-transitory computer readable memory 166 included in the camera. The camera 150, 150A includes computer readable instructions 168 (e.g. an application) stored in the memory 166, and computer readable data 170, also stored in the memory. The computer readable instructions 168 and computer readable data 170 are used by the camera to connect to the room created by the PC 112, provide calibration assistance and data, and transmit captured images and videos to the PC, for example. Computer readable instructions 168 may be broken down into blocks of code or modules. The memory 166 may be divided into one or more constituent memories, of the same or different types. The camera 150, 150A includes the display screen 158, operably connected to the processor(s) 164. In other embodiments an alternate display screen is included as a separate device, which is arranged to display the composited video to the camera operator 152. The display screen 158 may be a traditional screen, a touch screen, a projector, an electronic ink display or any other technological device for displaying information. The camera 150, 150A also includes a tracking module 172, such as a group of accelerometers and a magnetometer, operably connected to the processor 164.

The headset 52, controllers 56, camera 150 and PC 112 communicate via a cross-device communication network 180, 182, such as WiFi, Bluetooth™, etc.

### C. Exemplary Method

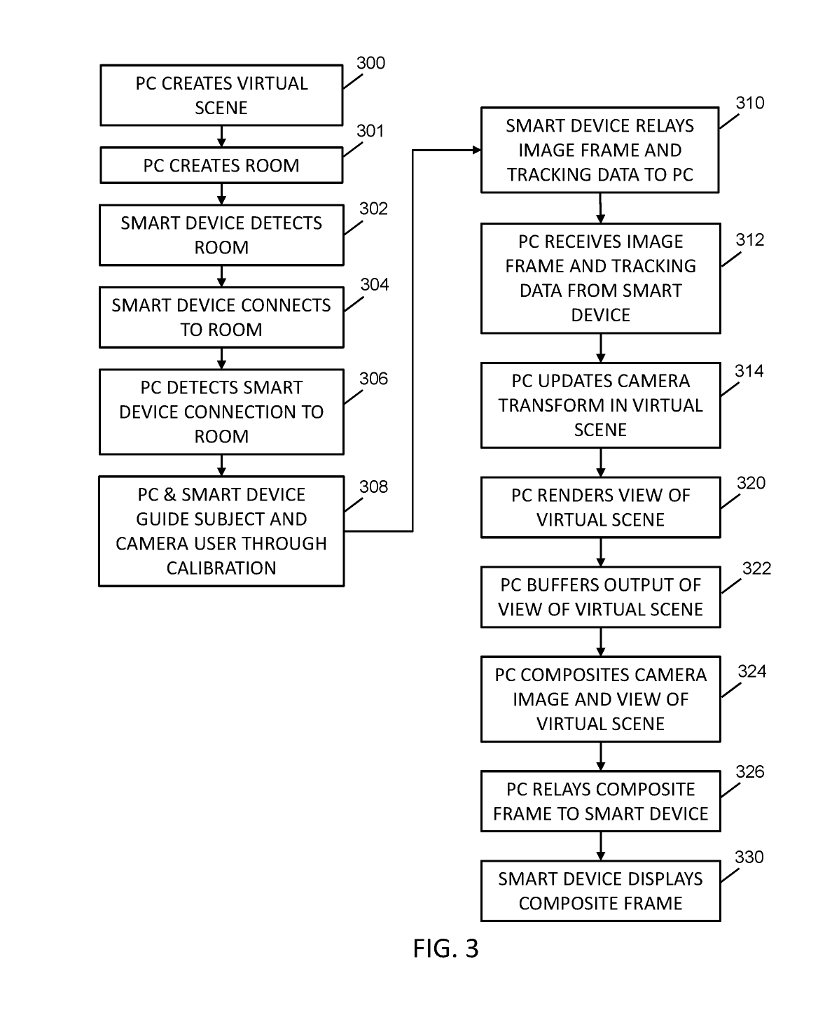

Referring to FIG. 3, an exemplary method performed by the system for MR video production is shown. This occurs in a scenario where a VR user (i.e. a subject) is experiencing a VR application, while a second user (a camera user) holds a smart device such as a phone or tablet which is capable of simultaneous localization and mapping (SLAM), also known as positional/rotational tracking.

In step 300, the PC 112 creates a virtual scene that the subject 50 experiences by “inhabiting” it. In step 301, the PC 112 creates a room 140 that is associated with the VR scene that the subject 50 is inhabiting. The room is visible to the network used for communication to and from the PC, for example a WiFi network. In step 302, a smart device held by a camera user detects the presence of the room. In step 304, the smart device connects to the room.

In step 306, the PC detects the connection of the smart device to the room, which triggers the PC and smart device to simultaneously guide the subject and camera user through a spatial calibration process in step 308. In some embodiments, guidance may be given entirely by the PC. The calibration process results in a determination of a transformation from one coordinate space to another, which acts on positions and rotations. For example, it results in a transformation from the camera's coordinate space to the virtual scene's coordinate space. This allows the position and rotation of the camera in the virtual scene's frame of reference to be determined each frame, given the camera's position and rotation in the camera's frame of reference. The subject's position and rotation relative to the virtual scene is determined through direct VR-PC interaction. This is required to synchronize tracking coordinates for the VR headset and the smart device, since the VR tracking system and the smart device tracking system (e.g. SLAM) coordinates are based on different frames of reference.

Calibration involves taking one or more snapshots of the states of both tracking systems at the same moment in time. A state is considered to be the position and rotational orientation of a tracked object. These snapshots are then examined to calculate a best-fit representation of the difference between position and orientation of the two objects' frames of reference. The conditions under which a user is expected to trigger these snapshots are designed to provide information that can tie the two systems together. For example, the subject is requested to place the VR headset on the floor, while the camera user is requested to point the smart device at the headset so that it is centered in the frame of the camera through a crosshair. The camera user then triggers a snapshot. The camera system, which has a concept of the floor height, can then calculate positional coordinates for the headset in its AR frame of reference. The camera system can determine the floor height through available AR interfaces, which calculate approximately flat surfaces. By comparing the positional coordinates and the photographed orientation of the headset to the PC's reported headset position and orientation, an offset between the camera's frame of reference and the VR frame of reference can be determined. The offset can then be used in the future to maintain visually matching tracking. The field of view can be deduced by the PC from the type of smart device and its camera's current zoom setting. An alternative solution is for two samples to use crosshairs offset vertically, as is currently used for VR quick alignment. For example, if the first crosshair is positioned 25% down from the top of the screen and the second is 75% down from the top, then the use of trigonometry on the two resulting vectors from the camera position to the headset position can resolve the vertical camera field of view. Multiple calibration shots can be taken from different positions in order to provide a more robust calibration.

In step 310 the smart device relays both a frame of camera image data and spatial tracking data to the PC via a wireless connection. The camera image data includes the subject and the background to the subject. The spatial tracking data includes the position and orientation of the camera at the moment that the camera captured the image of the subject and background in the frame of reference of the smart device. In step 312 the PC receives both the camera image frame data and spatial tracking data from the smart device via the wireless connection.

In step 314, the PC application updates the camera transform, in order to update the camera's position and orientation in the virtual scene in which the subject is present. In step 320, the PC creates a view of the virtual scene from the perspective of the camera, at the moment when the camera captured the image.

Since the positional and orientational data of the camera may arrive at the PC before the corresponding image data, due to latency in the camera feed, the PC optionally buffers the rendered view of the scene for a time period equal to the latency of the camera feed, in step 322. As a result, the synchronization between the virtual rendering and the camera feed is maintained.

Depending on the embodiment, the camera hardware itself may introduce 0-1 seconds of latency. Network latency will vary based on the type of connection, the hardware performance, and the parameters and quality of video data being streamed. In total, the latency could range from 0 to 5 seconds. If present, the latency may also vary per frame, which means that video frames should in this case be time-stamped when transmitted for more consistent playback.

After the buffering, the PC in step 324 then composits the subject of the camera image, after chroma keying to remove the background set, with the rendering of the virtual scene. In step 326, the PC then wirelessly relays an image frame of the view of the composited scene to the smart device, which, in step 330, displays the view of the composited scene on a screen on the smart device.

Steps 310-330 are repeated as the camera captures subsequent video frames, to result in an MR video of the subject in the virtual scene.

### D. Variations

While the present embodiment describes the best presently contemplated mode of carrying out the subject matter disclosed and claimed herein, other embodiments are possible.

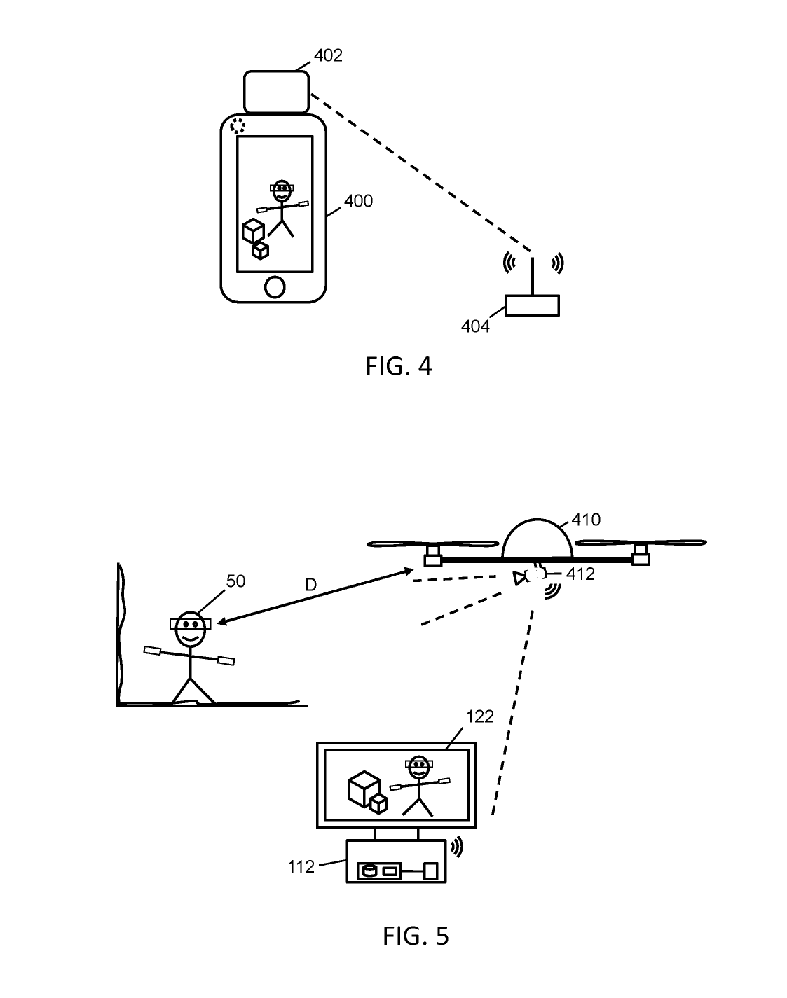

FIG. 4 shows a camera device 400 that is used instead of camera 150 in the system for MR video production. The camera device 400 either does not have its own tracking system, or it is not desired to use the camera device's tracking system. Instead, a tracking device 402 is physically attached to the camera device 400. The tracking device 402 is used to monitor the position and orientation of the camera device 400. The tracking device communicates with the PC 112 via a WiFi router 404 or directly via Bluetooth™ or other transmission protocol. The tracking device 402 may form part of the group of tracking devices used to track the subject's headset 52 and controllers 56. Note that the tracking device does not physically constrain the camera 400.

FIG. 5 shows an embodiment in which the camera device 150 of the system for MR video production is replaced by a drone 410 that carries a camera 412. The position, orientation and image data is transmitted wirelessly to the PC 112, and the composited scene is displayed on the screen 122 of the PC. The camera 150 should therefore be capable of uni-directional video transmission. The camera user controls the position and orientation of the drone, while at the same time observing the composited scene on the screen 122 for feedback. Note that the attachment of the camera 412 to the drone 410 does not physically constrain the camera. In other embodiments, a separate screen may be used from that of the PC.

In some embodiments, the drone may be a quadcopter capable of semi-autonomous flight control equipped with a camera, and the camera may have an additional remote control. Either the primary device (e.g. PC) or secondary device (e.g. drone processor) may be running additional routines to control the drone's position and/or rotational orientation based on available data. For example, a drone may be assigned to maintain a certain positional offset D from the subject's 50 head, while ensuring that its camera remains pointed at the subject's approximate center of mass.

In some embodiments, the camera may not provide spatial tracking capabilities itself, but instead eschew camera motion after initial calibration of its position and orientation, and produce a stationary camera perspective only. In some embodiments, the camera is not a smart phone.

In some embodiments, the camera device 150 may not display the composited output display. For example, the display of the camera device 150 may be switched off, or the camera device may have no display capability.

The camera 150 in the system for MR video production has the ability to turn 360° about a vertical axis without full coverage, by excluding regions of the camera feed which are not found to be inside an approximation of the subject's bounds. The bounds are calculated by considering the ranges of the headset and controller positions. However, the zone without coverage may be reduced by covering more of the subject's real space with a green screen or other removable background.

While the green screen has been described as being green, other colors are also possible for the background screen.

Alternative background removal methods may be employed instead of chroma keying. One example is accessing depth data for each pixel from a depth-sensing camera and discarding pixels of the camera feed behind the player, who is in the foreground. This requires transmitting the depth map from the camera 150 to the PC 112. Another example is by pre-sampling the background colors in the camera feed and discarding pixels that are similar to that sample. The main requirement is that the background be digitally removable from a video of a subject in the foreground.

The video feeds that are transmitted may include audio, or the audio may be transmitted in a separate audio connection.

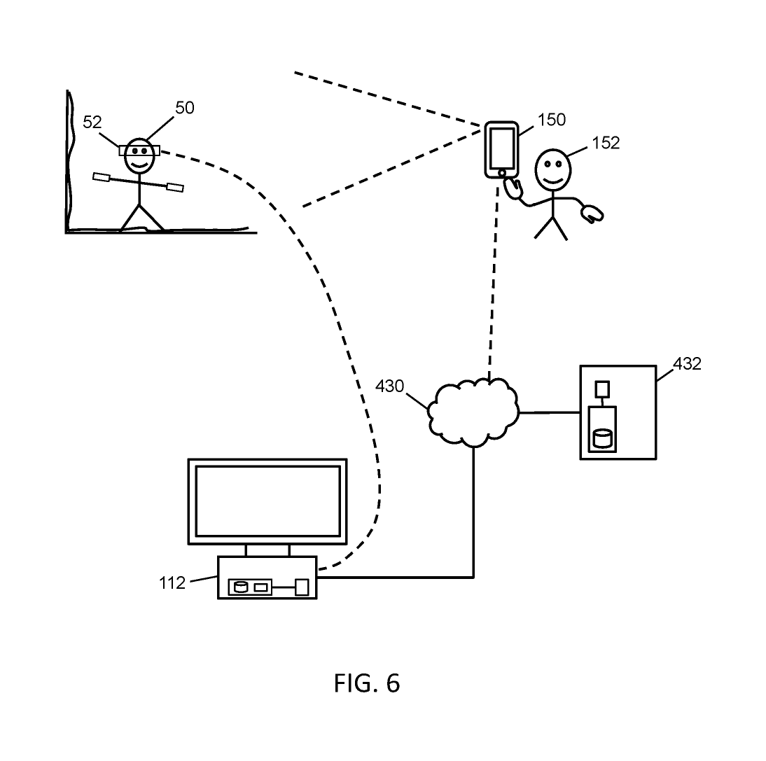

In some embodiments, rather than on the PC running the original application, the compositing and camera feed processing can be “off-loaded” to another processing device such as a server on the internet or local network. In this respect, the compositing is detached. This reduces the performance requirements of the PC and camera device at the cost of network bandwidth. In this case, either the virtual scene image frames (behind the user/in front of the user) are transmitted to the server, or the visual scene is synchronized with the server through state synchronization techniques, such as those used in multiplayer games. FIG. 6 shows the PC 112, headset 52 of the subject 50, and camera 150 of the camera operator 152 all connected to network 430, to which is connected a server 432 for compositing and camera feed processing.

In general, unless otherwise indicated, singular elements may be in the plural and vice versa with no loss of generality.

Throughout the description, specific details have been set forth in order to provide a more thorough understanding of the invention. However, the invention may be practiced without these particulars. In other instances, well known elements have not been shown or described in detail and repetitions of steps and features have been omitted to avoid unnecessarily obscuring the invention. Accordingly, the specification and drawings are to be regarded in an illustrative, rather than a restrictive, sense.

The detailed description has been presented partly in terms of methods or processes, symbolic representations of operations, functionalities and features of the invention. These method descriptions and representations are the means used by those skilled in the art to most effectively convey the substance of their work to others skilled in the art. A software implemented method or process is here, and generally, understood to be a self-consistent sequence of steps leading to a desired result. These steps require physical manipulations of physical quantities. Often, but not necessarily, these quantities take the form of electrical or magnetic signals or values capable of being stored, transferred, combined, compared, and otherwise manipulated. It will be further appreciated that the line between hardware and software is not always sharp, it being understood by those skilled in the art that the software implemented processes described herein may be embodied in hardware, firmware, software, or any combination thereof. Such processes may be controlled by coded instructions such as microcode and/or by stored programming instructions in one or more tangible or non-transient media readable by a computer or processor. The code modules may be stored in any computer storage system or device, such as hard disk drives, optical drives, solid state memories, etc. The methods may alternatively be embodied partly or wholly in specialized computer hardware, such as ASIC or FPGA circuitry.

It will be clear to one having skill in the art that further variations to the specific details disclosed herein can be made, resulting in other embodiments that are within the scope of the invention disclosed. Steps may be added to the flowchart, or one or more steps may be removed without altering the main function of the system. Configurations described herein are examples only and actual ones of such depend on the specific embodiment. Accordingly, the scope of the invention is to be construed in accordance with the substance defined by the following claims.

1. A method for producing a mixed reality video comprising the steps of:
creating, by a processor, a virtual reality scene;
detecting, by the processor, a wireless connection of a detached camera to the processor;
guiding a subject experiencing the virtual scene through a calibration process that results in a determination of a transformation matrix from a frame of reference of the camera to a frame of reference of the virtual reality scene;
receiving, by the processor, a video frame of the subject and a background to the subject captured by the camera;
receiving, by the processor, a position and orientation of the camera in the camera's frame of reference corresponding to when the camera captured the video frame;
determining, by the processor, a position and orientation of the camera in the frame of reference of the virtual scene using the transformation matrix;
creating, by the processor, a view of the virtual scene from a perspective of the position and orientation of the camera in the frame of reference of the virtual scene;
removing, by the processor, the background from the video frame;
compositing the video frame of the subject with the view of the virtual scene; and
relaying the composited view of the virtual scene to a display device.

2. The method according to claim 1, wherein the display device is on the camera.

3. The method according to claim 1, further comprising the processor guiding the subject through said calibration process.

4. The method according to claim 3, further comprising the camera guiding a user of the camera through said calibration process simultaneously with the processor guiding the subject through said calibration process.

5. The method according to claim 1, further comprising:
receiving, by the processor, subsequent video frames of the subject and the background to the subject captured by the camera;
receiving, by the processor, a position and orientation of the camera in the camera's frame of reference corresponding to each subsequent video frame;
updating, by the processor, the position and orientation of the camera in the frame of reference of the virtual scene for each subsequent video frame;
creating, by the processor, a view of the virtual scene from a perspective of each updated position and orientation of the camera in the frame of reference of the virtual scene;
removing, by the processor, the background from each subsequent video frame;
compositing each subsequent video frame of the subject with each corresponding view of the virtual scene; and
relaying each composited view of the virtual scene in sequence to the display device.

6. The method according to claim 1, further comprising buffering the view of said virtual scene before the compositing step in order to compensate for a delay in a feed of the video frame from the camera to the processor.

7. The method according to claim 1, wherein the camera is handheld by a user of the camera.

8. The method according to claim 1, wherein the camera is mounted on a drone.

9. The method according to claim 8, further comprising;
maintaining the drone at a fixed positional offset from the subject; and
maintaining the camera pointed at the subject.

10. The method according to claim 1, further comprising:
creating, by the processor, a virtual room that is associated with the virtual reality scene; and
detecting, by the processor, a connection of the camera to the virtual room.

11. The method according to claim 1, further comprising displaying the composited view on the display device.

12. A system for producing a mixed reality video comprising:
a physically detached camera;
a background set;
a display device; and
a processor configured to:
create a virtual reality scene;
detect a wireless connection of the camera to the processor;
guide a subject experiencing the virtual scene through a calibration process that results in a determination of a transformation matrix from a frame of reference of the camera to a frame of reference of the virtual reality scene;
receive a video frame of the subject and the background set captured by the camera;
receive a position and orientation of the camera in the camera's frame of reference corresponding to when the camera captured the video frame;
determine a position and orientation of the camera in the frame of reference of the virtual scene;
create a view of the virtual scene from a perspective of the position and orientation of the camera in the frame of reference of the virtual scene;
remove the background from the video frame;
composit the video frame of the subject with the view of the virtual scene; and
relay the composited view of the virtual scene to the display device.

13. The system according to claim 12, wherein the display device is on the camera.

14. The system according to claim 12, wherein:
the processor is configured to guide the subject through said calibration process; and
the camera is configured to guide a user of the camera through said calibration process simultaneously as the processor guides the subject through said calibration process.

15. The system according to claim 12, further comprising a buffer configured to buffer the view of said virtual scene before the video frame of the subject is composited with the view of the virtual scene.

16. The system according to claim 12, wherein the camera is rotatable about a vertical axis by 360°.

17. The system according to claim 12, wherein the camera is mounted on a drone.

18. The system according to claim 12, further comprising a tracking device attached to the camera, wherein the tracking device is configured to transmit positions and orientations of the camera to the processor.

19. The system according to claim 12, wherein the processor comprises:
a first processor in a computer that is configured to at least create the virtual reality scene; and
a second processor in a server separate from the computer, wherein the server is configured to at least composit the video frame of the subject with the view of the virtual scene.

20. A non-transitory computer readable medium comprising computer-readable instructions, which, when executed by a processor cause the processor to:
create a virtual reality scene;
detect a wireless connection of a detached camera to the processor;
guide a subject experiencing the virtual scene through a calibration process that results in a determination of a transformation matrix from a frame of reference of the camera to a frame of reference of the virtual reality scene;
receive a video frame of the subject and a background to the subject captured by the camera;
receive a position and orientation of the camera in the camera's frame of reference corresponding to when the camera captured the video frame;
determine a position and orientation of the camera in the frame of reference of the virtual scene;
create a view of the virtual scene from a perspective of the position and orientation of the camera in the frame of reference of the virtual scene;
remove the background from the video frame;
composit the video frame of the subject with the view of the virtual scene; and
relay the composited view of the virtual scene to the display device.
